(19) United States
(12) Patent Application Publication
(10) Pub. No.: US 2006/0100371 A1
(43) Pub. Date: May 11, 2006

(54) Polymer blends of a monovinylarene conjugated diene block copolymer and a monvinylarene acrylate copolymer

(76) Inventors: David Robert Foss, Chesapeake, VA (US); Calvin Joseph Zongolowicz II, Virginia Beach, VA (US); John D. Wilkey, Owasso, OK (US)

Correspondence Address: Suzanne Kikel;NOVA Chemicals Inc., 400 Frankfort Road, Monaca, PA, 15061, US

(21) Appl. No.: 11/266,163

(22) Filed: Nov. 3, 2005

Related U.S. Application Data
(60) Provisional application No. 60/625,996, filed on Nov. 8, 2004.

(51) Int. Cl. C08L 53/00

(52) U.S. Cl. 525/88

(57) ABSTRACT

Polymer blends with low haze and increased modulus and impact strength are comprised of a styrene butadiene block (SBC) copolymer and at least 62.5 weight percent of a styrene methyl methacrylate copolymer (SMMA). The SBC comprises 30 to 40, preferably 38 weight percent, butadiene. In a first embodiment the SBC comprises at least one tapered block. In a second embodiment, the SBC comprises at least two modes; at least one tapered block where the styrene comprises less than 25 weight percent; first and second charges of styrene with a weight ratio of 1:2 to 2:1; a monoblock formed from the first charge of styrene in the block copolymer preceding the tapered blocks having a molecular weight of 25,000 to 65,000 grams per mole, and the block copolymer having a blocking force of less than 175 pounds. The SMMA contains at least 55 weight percent styrene and no more than 45 weight percent methyl methacrylate. The blends have a haze of less than about 2.0%, a flexural modulus greater than 280000 pounds per square inch, Gardner impact strength of 5 ft-lbs/inch, preferably, greater than about 20 ft-lbs/inch, as measured according to ASTM D5420, and a tensile elongation greater than 20%.

### BACKGROUND OF THE INVENTION

1. Field of the Invention

The present invention relates to polymer blends comprising a monovinylarene conjugated diene block copolymer, e.g. styrene-butadiene block copolymer, and a monovinylarene acrylate copolymer, e.g. styrene-methyl methacrylate copolymer. Related methods and articles prepared from the polymer blends are also provided.

2. Background Art

Monovinylarene conjugated diene copolymers are known and useful for a variety of purposes. Examples of such copolymers for impact resistance are disclosed in U.S. Pat. No. 4,195,136 to Yasushi Sato, et al Mar. 25, 1980 and assigned to Asahi Kasei Kogyo Kabushiki Kasha.

It is also known that polymer blend compositions of the above described copolymers and copolymers of vinylarenes and acrylates result in impact resistance. Examples of such polymer blends are disclosed in U.S. Pat. Nos. 4,386,190 and 5,777,030.

The aforesaid U.S. Pat. No. 4,386,190 issued to Fay W. Bailey on May 31, 1983 and assigned to Phillips Petroleum Company discloses and claims a high impact resistance composition comprising a blend consisting of a (a) resinous, essentially non-elastomeric block copolymer of from 30-36 weight percent of a conjugated diene, e.g. butadiene and from 64-70 weight percent of a vinylarene, e.g. styrene, and (b) a copolymer consisting of a vinylarene, e.g. styrene, and an acrylate, e.g. methyl methacrylate copolymer. Preferably, component (a) is a butadiene-styrene copolymer and component (b) is a styrene-methyl methacrylate copolymer. These polymer blends have important applications as ingredients in molded articles of manufacture, particularly in food containers, which are highly susceptible to damage resulting in loss of the food product during shipping.

The aforesaid U.S. Pat. No. 5,777,030 issued to Mark D. Hanes et al Jul. 7, 1998 and assigned to Phillips Petroleum Company discloses and claims polymer blend compositions having improved impact properties while retaining good mechanical properties. The polymer blend composition comprises (A) a monovinylarene/conjugated diene block copolymer in an amount ranging from about 90 to 25 weight percent and (B) a styrenic copolymer of styrene/methyl methacrylate in an amount ranging from about 10 to 75 weight percent based on the total weight of the blend composition. Preferably, component (A) is a styrene-butadiene copolymer having a styrene content ranging from about 95 to 71 weight percent and a butadiene content ranging from about 9 to about 29 weight percent based on the total weight of component (A). Preferably, component (B) is styrene methyl methacrylate copolymer having a styrene content ranging from about 95 to about 50 weight percent and a methyl methacrylate content ranging from about 5 to about 50 weight percent based on the styrenic copolymer. The melt flow rate of the styrene-butadiene copolymer, i.e. component (A), ranges from about 10 grams/10 min. to about 25 grams/10 min. measured according to ASTM D-1238 (1994), Condition G.

The polymer blend compositions of the aforesaid U.S. Pat. No. 5,777,030 can be formed into articles possessing high impact properties of increased toughness, while maintaining good mechanical properties. The haze is preferably less than 5%; the flexural modulus is greater than 220 kilopounds and the Notched IZOD impact is greater than 0.41 ft-lbs/inch. The resultant articles have numerous applications, such as display racks, crisper trays, and components of toys.

However, it is desirable to develop lower haze polymer blends of monovinylarene conjugated diene block copolymer and monovinylarene acrylate copolymer with increased modulus and impact strength.

### SUMMARY OF THE INVENTION

The present invention provides such polymer blends.

A first embodiment of the invention relates to a polymer blend composition comprising:

a monovinylarene-conjugated diene block copolymer; and

a monovinylarene acrylate copolymer;

wherein said monovinylarene conjugated diene block copolymer comprises from about 30 weight percent to about 40 weight percent diene;

wherein said monovinylarene acrylate copolymer is present in said polymer blend composition in an amount of at least 62.5 weight percent and comprises at least 55 weight percent monovinylarene and no more than 45 weight percent acrylate.

A method related to the first embodiment of the invention involves increasing the modulus and impact strength of a low haze blend of monovinylarene conjugated diene block copolymer and monovinylarene acrylate copolymer, the steps comprising:

blending at least 62.5 weight percent of said monovinylarene acrylate copolymer with said monovinylarene conjugated diene block copolymer to form a polymer blend composition;

wherein said monovinylarene acrylate copolymer is comprised of at least 55 weight percent monovinylarene and no more than 45 weight percent acrylate, and

wherein said monovinylarene conjugated diene block copolymer is comprised of diene in an amount ranging from about 30 to 40 weight percent based on the weight of said monovinylarene conjugated diene block copolymer.

A second embodiment of the invention comprises a polymer blend composition comprising:

a monovinylarene-conjugated diene block copolymer comprising: at least two modes; at least one tapered block comprising less than 25 weight percent monovinylarene (on a block copolymer basis); from 30 weight percent to about 40 weight percent diene; a first and second charge of monovinylarene having a ratio of 1:2 to 2:1; a monoblock formed from the first charge of monovinylarene in the block copolymer preceding the tapered blocks having a molecular weight in the range of 25,000 to 65,000 grams per mole; and a blocking force of less than 175 pounds; and

at least 62.5 weight percent of a monovinylarene acrylate copolymer. The composition has a haze of less than about 2.0%; a modulus greater than 280 kilopounds per square inch; and Gardner impact strength greater than 5 ft-lbs/inch as measured according to ASTM D5420.

A method related to the second embodiment of the invention involves increasing the modulus and impact strength of a low haze blend of monovinylarene conjugated die block copolymer and monovinylarene acrylate copolymer, comprising the step of:

blending at least 62.5 wt % of a monovinylarene acrylate copolymer with a monovinylarene conjugated diene block copolymer;

wherein the block copolymer comprises at least two modes; at least one tapered block comprising less than 25 weight percent monovinylarene (on a block copolymer basis); a first and second charge of monovinylarene having a weight ratio of 1:2 to 2:1; 30 to 40 weight percent diene, a monoblock formed from a first charge of monovinylarene in the block copolymer preceding the tapered blocks having a molecular weight ranging from 25,000 to 65,000 grams per mole, and a blocking force of less than 175 pounds.

These blends of the invention have a haze of less than about 2.0% with a visual appearance that is largely free of milky blue cast typical of materials of this type; a flexural modulus greater than 280 kilopounds per square inch; Gardner impact strength greater than 5 ft-lbs/inch as measured according to ASTM D5420; and a tensile elongation greater than 20%.

Preferably, the monovinylarene conjugated diene block copolymer is a styrene butadiene copolymer, and preferably, the monovinylarene acrylate copolymer is a styrene methyl methacrylate copolymer.

In some embodiments, the present invention provides polymer blends with exceptional clarity, toughness, and stiffness.

In some embodiments, the present invention provides polymer blends with improved high impact resistance and increased modulus and a low haze comprised of a monovinylarene conjugated diene block copolymer and a monovinylarene acrylate copolymer.

In some embodiments, the present invention provides methods for increasing the modulus and impact strength and the low haze of polymer blends comprised of a monovinylarene conjugated diene block copolymer and a monovinylarene acrylate copolymer.

In some embodiments, the present invention provides articles made from the polymer blends of the invention that have an increased modulus and impact strength and low haze.

In some embodiments, the present invention provides polymer blends that have at least 62.5 weight percent of a monovinylarene acrylate copolymer blended with a monovinylarene-conjugated diene block copolymer.

In some embodiments, the present invention provides polymer blends comprised of a monovinylarene-conjugated diene block copolymer and a monovinylarene acrylate copolymer wherein the monovinylarene-conjugated diene block copolymer is comprised of a butadiene rubber in an amount ranging from about 30 to about 40 weight percent based on the weight of the monovinylarene-conjugated diene block copolymer.

These and other aspects of the present invention will be better appreciated and understood by those skilled in the art from the following description and appended claims.

### DETAILED DESCRIPTION OF THE INVENTION

The polymer blends of the invention are comprised of a monovinylarene conjugated diene block copolymer and a monovinylarene acrylate copolymer. The monovinylarene conjugated diene block copolymer is present in the polymer blends in an amount ranging from about 0.1 weight percent to at most 37.5 weight percent based on the total weight of the polymer blend, and preferably from about 28 weight percent to about 36 weight percent, and more preferably in an amount of about 36 weight percent.

The monovinylarene acrylate copolymer is present in the polymer blends in an amount of at least 62.5 weight percent to 99.9 weight percent based on the total weight of the polymer blend, and preferably from about 64 weight percent to about 72 weight percent, and more preferably in an amount of about 64 weight percent.

Insufficient amounts of the monovinylarene conjugated diene block copolymer could result in the polymer blend composition not exhibiting impact, and insufficient amounts of the monovinylarene acrylate copolymer could result in the polymer blend composition not exhibiting desired stiffness.

The monovinylarene conjugated diene block copolymer is selected or prepared such that it has a melt flow rate from about 3.0 to about 12 grams/10 minutes at 200° C./5 kg, more preferably from about 3.0 to 10 grams/10 minutes, e.g., between 3.2 to 6.9 grams per 10 minutes.

Generally, the monovinylarene is present in the monovinylarene conjugated diene block copolymer in an amount in the range of from about 30 weight percent to about 70 weight percent based on the weight of the monovinylarene conjugated diene block copolymer. Preferably, the monovinylarene is present in the block copolymer in the range of from about 60 weight percent to about 66 weight percent based on the weight of the monovinylarene conjugated diene block copolymer; and more preferably the monovinylarene is present in an amount of 62 weight percent.

The conjugated diene is generally present in the block copolymer in an amount in the range of from about 30 percent to about 70 weight percent based on the weight of the monovinylarene-conjugated diene block copolymer. Preferably the conjugated diene is present in the block copolymer in an amount in the range of from about 30 weight percent to about 40 weight percent based on the weight of the monovinylarene conjugated diene block copolymer. Narrower ranges may also be desired in particular embodiments, such as any specific value from 30 to 40 wt %, 30 to 32 wt %, 30 to 34 wt %, 30 to 36 wt %, 30 to 38 wt %, 32 to 34 wt %, 32 to 36 wt %, 32 to 38 wt %, 34 to 36 wt %, 34 to 38 wt %, 36 to 38 wt %, greater than 32 wt %, greater than 34 wt %, greater than 36 wt %, greater than 38 wt %, etc.

Suitable conjugated dienes, which may be used in the block copolymers, include those having 4 to 12 carbon atoms per molecule, with those having 4 to 8 carbon atoms preferred. Examples of such suitable compounds include but are not limited to 1,3-butadiene, 2-methyl-1,3-butadiene, 2-ethyl-1,3,-butadiene, 2,3-dimethyl-1,3-butadiene, 1,3-pentadiene, 3-butyl-1,3-octadiene, and mixtures thereof. The preferred dienes are 1,3-butadiene and isoprene, and the most preferred is 1,3-butadiene, as they are most readily available.

Suitable monovinylarene compounds, which may be used in the copolymers, include those having 8 to 18 carbon atoms per molecule, preferably 8 to 12 carbon atoms. Examples of such suitable compounds include, but are not limited to styrene, alpha-methylstyrene, 2-methylstyrene, 3-methylstyrene, 4-methylstyrene, 2-ethylstyrene, 3-ethylstyrene, 4-ethylstyrene, 4-n-proplystyrene, 4-t-butylstyrene, 2,4-dimethylstyrene, 4-cyclohexylstyrene, 4-decylstyrene, 2-ethyl-4-benzylstyrene, 4-(4-phenyl-n-butyl) styrene, 1-vinylnaphthalene, 2-vinylnaphthalene, and mixtures thereof. Styrene is the preferred monovinylarene compound due to ease of polymerization.

A “monovinylarene-conjugated diene block copolymer” is a polymer comprising monovinylarene units and conjugated diene units. The polymer comprises one or more blocks, wherein each block comprises monovinylarene units or conjugated diene units. If it comprises only one type of units, it can be termed a “monoblock”. If it comprises both, it can be a random block, a tapered block, a stepwise block, or any other type of block.

In the invention, the monovinylarene-conjugated diene copolymer is a block copolymer comprising styrene blocks and butadiene blocks (a “styrene-butadiene copolymer”). An example of a styrene-butadiene copolymer is commercially available under the K-Resin® trademark (Chevron Phillips Chemical Co., The Woodlands, Tex.). This type of styrene-butadiene copolymer may be used in a first embodiment of the invention.

In a first embodiment of the invention, the monovinylarene conjugated diene block copolymer may be a styrene-butadiene copolymer with at least one tapered block.

A block is “tapered” when both (a) the mole fraction of conjugated diene units in a first section of the block is higher than the mole fraction of conjugated diene units in a second section of the block, wherein the second section of the block is closer to a given end of the block, and (b) condition (a) is true for substantially all sections of the block.

In a second embodiment of the invention, the monovinylarene conjugated diene block copolymer is multi-modal. Analytically, this is evidenced by a population of block copolymer molecules having two or more peaks in a histogram of the population's molecular weight distribution. In practice, each injection or charge of a polymerization initiator results in an additional mode. For example, a bimodal block copolymer is formed through the injection of at least two polymerization initiator charges, and so on. As an example, it will be appreciated that multi-modal copolymers can be prepared by blending unimodal copolymers.

The monovinylarene conjugated diene block copolymer of the second embodiment comprises at least one tapered block. However, this copolymer may have from 1 to 3 tapered blocks, or from 2 to 3 tapered blocks. If the copolymer comprises 2 to 3 tapered blocks, these blocks are adjacent i.e. directly bonded to each other.

The block copolymers of the second embodiment may be selected or prepared such that the monovinylarene in the tapered portion of the blocks comprises less than 25 weight percent of the block copolymer. The weight percent of the monovinylarene may be 12 weight percent or less.

In the second embodiment, the block copolymers may be selected or prepared such that they comprise two monoblocks of monovinylarene. As an example, these monoblocks can be formed by sequential first and second charges of monovinylarene and the ratio of the first charge to the second charge may range from about 1:2 to about 2:1. In some applications, a broader ratio may be desired, for example, from 1:3 to about 3:1.

The monoblock formed from a first charge of monovinylarene in the block copolymer preceding the tapered blocks may have a molecular weight ranging from about 25,000 to about 65,000 grams per mole (g/mol). This measure, which is generally taken immediately following the first charge of monovinylarene, is sometimes referred to as pre-molecular weight (Pre-MW). Other ranges may also be desired, for example, 30,000 to 60,000 g/mol; 40,000 to 50,000 g/mol; and 50,000 to 60,000 g/mol.

In the second embodiment, the block copolymer is selected or prepared such that it has a blocking force of less than 175 pounds. In this context, the blocking force refers to the amount of force required to break apart pellets of the block copolymer according to the following standardized test. First, the block copolymer is formed into pellets, by the methods described herein below, for example. Three hundred grams of sample pellets are placed in a PVC cylinder having an internal diameter of 3 inches, and a 2.5 kilogram weight is placed on top the pellets. The cylinder and contents are placed in a forced air oven at 150° F. for 90 hours. After cooling to room temperature, the pellets, in aggregate form, are removed from the cylinder and placed in an INSTRON model 4505 and tested in compression. The anti-blocking property of the samples is specified by the pounds-force required to break apart the pellet aggregate.

The basic starting materials and polymerization conditions for preparing the monovinylarene-conjugated diene block copolymers of the second embodiment are disclosed for example in U.S. Pat. Nos. 4,091,053; 4,584,346; 4,704,434; 4,704,435; 5,130,377; 5,227,419; 6,265,484; 6,265,485; 6,420,486; and 6,444,755, which are hereby incorporated in their entirety by reference.

The block copolymer is prepared by forming, and coupling the following polymer chain structures:

Sequence 1: S₁ S₂ B₁/S₃ B₂/S₄ B₃/S₅ Li

Sequence 2: S₂ B₁/S₃ B₂/S₄B₃/S₅ Li

wherein S represents monovinylarene, i.e. styrene blocks, B/S represents tapered blocks of conjugated diene-monovinylarene, i.e. butadiene-styrene, and Li represents the residue from the monoalkali metal initiator, i.e. n-butyl lithium.

Generally, each block is formed by polymerizing the monomer or mixture of monomers from which the desired units of the block are derived. The following descriptions of the polymerization process will generally apply to the formation of all types of blocks in the inventive polymer.

The polymerization process may be carried out in a hydrocarbon diluent at any suitable temperature in a range of −100° C. to 150° C., preferably in the range of 0° C. to 150° C., and at a pressure sufficient to maintain the reaction mixture substantially in the liquid phase. Preferred hydrocarbon diluents include linear and cycloparaffins, such as pentane, hexane, octane, cyclohexane, cyclopentane, and mixtures thereof. Cyclohexane is preferred.

The polymerization process may be carried out in the substantial absence of oxygen and water, such as under an inert gas atmosphere.

The polymerization process may be performed in the presence of an initiator. The initial may be an organomonoalkali metal compound that is a known initiator. The initiator may have the formula RM, where R is an alkyl, cycloalkyl, or aryl radical containing 4 to 8 carbon atoms, such as an n-butyl radical, and M is an alkali metal, such as lithium. Preferred initiators are n-butyl lithium, sec-butyl lithium, and t-butyl lithium.

The amount of initiator employed may depend upon the desired polymer or block molecular weight, as is known in the art, and is readily determinable, making due allowances for traces of reaction poisons in the feed streams.

The polymerization process may involve the inclusion of small amounts of randomizers. The randomizers may be polar organic compounds, such as ethers, thioethers, or tertiary amines. The randomizer may be a potassium salt or a sodium salt of an alcohol. The randomizer can be included in the hydrocarbon diluent to improve the effectiveness of the initiator, to randomize at least part of the monovinylarene monomer in a mixed monomer charge, or both. The inclusion of a randomizer can be of value when forming a random or tapered monovinylarene-conjugated diene block of the present polymer. Examples of randomizers include tetrahydrofuran, diethyl ether, potassium-tert-amylate, and mixtures thereof.

When forming a particular block, each monomer charge or monomer mixture charge can be polymerized under solution polymerization conditions such that the polymerization of each monomer charge or monomer mixture charge, to form the particular block, is substantially complete before charging a subsequent charge.

A coupling agent can be added after polymerization is complete. Suitable coupling agents are known to those skilled in the art. These include di-or multivinylarene compounds; alkoxytin compounds; di-or multihalides, such as silicon halides and halosilanes; di-or multiesters, such as the esters of monoalcohols with polycarboxylic acids; diesters which are esters of monobasic acids with polyalcohols such as glycerol; and mixtures of two or more such compounds. A useful multifunctional coupling agent includes epoxidized soybean oil.

Following completion of the coupling reaction, the polymerization reaction mixture can be treated with a terminating agent such as water, carbon dioxide, alcohol, phenols, or linear saturated aliphatic mono-or di-carboxylic acids, to remove alkali metal from the block copolymer or for color control.

After termination, the polymer cement (polymer in polymerization solvent) usually contains 10 to 40 weight percent solids. The polymer cement can be flashed to evaporate the solvent so as to increase the solids content to between 50 and 99 weight percent, followed by vacuum oven or devolatilizing extruder drying to remove the remaining solvent and to form pellets.

The block copolymer can also contain additives such as antioxidants, antiblocking agents, release agents, fillers, extenders, dyes, etc.

A method for producing a monovinylarene-conjugated diene block copolymer suitable for the composition of the invention comprises the following steps:

Sequentially contacting under polymerization conditions at least one monovinylarene monomer, an organomonoalkali metal initiator, at least one conjugated diene monomer, and thereafter coupling with a polyfunctional coupling agent to form the block copolymer. The block copolymer comprises the following: at least two modes; at least one tapered block; at least a first and a second charge of monovinylarene, wherein the first charge has a weight ratio to the second charge in the range of 1:2 to 2:1; from 30 to 40 weight percent diene; and a block force of less than 175 pounds. A monoblock formed from a first charge of monovinylarene in the block copolymer preceding the tapered blocks has a molecular weight in the range of 25,000 to 65,000 gram per mole, and the monovinylarene in at least one tapered block comprises less than 25 weight percent of the block copolymer.

Suitable monovinylarene conjugated diene copolymers for the inventive polymer blend is available from Chevron Phillips Chemical Company, LP, as disclosed in a U.S. patent application to John D. Wilkey et al., entitled Monovinylarene Conjugated Diene Copolymer Compositions For Acrylate Blends and filed on the same day as the present patent application. This patent application is hereby incorporated by reference in its entirety.

The monovinylarene acrylate copolymer for use in the invention may have a melt flow rate in the range of from about 0.2 grams/10 minutes to about 100 grams/10 minutes measured according to ASTM D-1238 (1994), condition G.

In some embodiments, in order to produce a final blend composition having a high degree of clarity, i.e. an acceptable low haze less than about 2% measured with a Gardner Hazemeter according to ASTM D-1003 (1992) using test specimens of 0.100 inch thickness, the monovinylarene acrylate copolymer (or monovinylarene-conjugated diene block copolymer) is selected such that no measurable difference in refractive index is present, measured according to ASTM D 542. Other methods for matching refractive index that are known to those skilled in the art may be used in the invention.

The monovinylarene acrylate copolymer is prepared by copolymerizing the monovinylarene with the acrylate. The monovinylarene preferably contains 8-20, and more preferably, 8-12 carbon atoms per molecule. Examples include styrene, alpha-methylstyrene, 1-vinylnaphthalene, 2-vinylnaphthalene and alkyl, cycloalkyl, aryl, alkaryl and aralkyl derivatives thereof. Examples of substituted monomers include 3-methylstyrene, 4-n-propylstyrene, 4-cyclohexylstyrene, 4-dodecylstyrene, 3-ethyl-4-benzylstyrene, 4-p-tolystyrene and 4-(4-phenyl-n-butyl) styrene. Examples of the acrylate include one substituted or unsubstituted alky acrylate, such as methylacrylate, ethylacrylate, isopropylacrylate, butylacrylate, methyl methacrylate, ethyl methacrylate, butyl methacrylate, hexyl methacrylate, cyclohexyl methacrylate, methyl ethacrylate, and the like or mixtures thereof.

The composition of suitable monovinylarene acrylate copolymers for use in the invention may vary. Generally, the acrylate, e.g. methyl methacrylate is present in the copolymer in an amount not to exceed 45 weight percent, preferably between about 20 weight percent to about 45 weight percent based on the weight of the copolymer. More preferably, the acrylate is present in an amount ranging from about 25 weight percent to about 35 weight percent based on the weight of the copolymer; and most preferably the acrylate is about 30 weight percent. Acrylate is needed in amounts sufficient to render blend compositions with desired toughness; however, too much acrylate could result in blend compositions with low clarity.

Generally, the monovinylarene, e.g. styrene, is present in the monovinylarene acrylate copolymer in an amount preferably at least 55 weight, and preferably between about 55 percent to about 80 weight percent based on the weight of the copolymer. More preferably, the monovinylarene is present in an amount ranging from about 65 weight percent to about 75 weight percent based on the weight of the copolymer; and most preferably, the monovinylarene is about 70 weight percent.

The preferred monovinylarene acrylate copolymer to be used in the inventive blends is a styrene-methyl methacrylate copolymer.

The monovinylarene acrylate copolymer generally can be prepared in accordance with any method known in the art. Typically the monovinylarene acrylate copolymer is prepared by copolymerization of monovinylarene and acrylic acid monomers employing a free radical initiator such as peroxy or azo compounds. A suitable monovinylarene acrylate copolymer is a styrene methyl methacrylate copolymer available commercially from NOVA Chemicals Inc., Pittsburgh, Pa., under the tradenames NAS 30, NAS 90, and NAS 21.

Any method known in the art is suitable for blending of the monovinylarene conjugated diene block copolymer and the monovinylarene acrylate copolymer. Preferably, the monovinylarene conjugated diene block copolymer and the monovinylarene acrylate copolymer are melt blended employing any desired means such as a Banbury mixer, a hot roll, an extruder, or an injection molder. More preferably the polymers are melt blended employing extruder-blending techniques for efficiency. Single or twin-screw extruders can be utilized. If desired, the two-copolymer blend components can be dry blended prior to the melt blending. Any method of dry blending known to those skilled in the art can be employed, such as, for example, utilization of a drum tumbler.

These methods for blending the components of the composition of the invention and the blending conditions are disclosed in the aforesaid U.S. Pat. No. 5,777,030, which is incorporated herein by reference in its entirety.

The blending conditions depend on the blending technique and the copolymers employed. If an initial dry blending of the copolymer components is employed, the blending conditions can be at temperatures from room temperature up to just under the lower melt processing temperature of either copolymer component, and blending times can be in the range of a few seconds to hours.

During melt blending, the temperature at which the two copolymer components are combined in the blender generally can be in the range between the higher melt processing point of either copolymer employed and up to just below the lower decomposition temperature of either copolymer. Generally, the copolymers are melt-blended for a time of about 0.5 to about 2.0 minutes for thorough mixing of the two-copolymer components with the least amount of copolymer degradation.

The polymer blends of the invention may contain additives, such as, for example, stabilizers, anti-oxidants, anti-blocking agents, mold release agents, dyes, pigments, and flame-retardants, as well as fillers and reinforcing agents, such as for example, glass fibers, as long as the amounts and type do not interfere with the aspects of the invention.

The polymer blends of the invention can be useful for the production of articles prepared, for example, by milling, extrusion or injection molding. Such articles may be medical devices, storage devices, floor care appliances, etc.

The aforesaid U.S. Pat. No. 5,777,030 discloses that the styrene/conjugated diene block copolymer is in the polymer blend in an amount ranging from about 25 weight percent to about 90 weight percent. Column 6, lines 18-31 states that the values of both Notched and Unnotched IZOD impact strength for the inventive polymer blends are consistently greater than those values for corresponding blends with monovinylarene-conjugated diene block copolymers and styrenic copolymers, wherein the monovinylarene conjugated diene block copolymer utilized does not exhibit the preferred flow rate and/or the blend composition has less than 25 weight percent of the monovinylarene conjugated diene block copolymer based on the total weight of the blend.

In the invention, the polymer blends will always comprise at least 62.5 weight percent of the monovinylarene acrylate copolymer, which means that the monovinylarene conjugated diene block copolymer will be no more than 37.5 weight percent.

The polymer blends of the invention exhibit haze of less than about 2.0, measured with a Gardner Hazemeter according to ASTM D-1003 (1992), using test specimens of 0.100 inches thickness; has a flexural modulus greater than 280 kilopounds per square inch, preferably ranging from about 300 to about 320 kilopounds per square inch; and has a Gardner impact strength greater than 5 ft-lbs/inch, preferably, greater than about 20 ft-lbs/inch, as measured according to ASTM D5420.

The following examples are intended to assist in understanding the present invention, however, these examples should not be interpreted as limiting the scope thereof.

### EXAMPLE 1

In this example, a general preparation of a styrene-butadiene block copolymer (SBC) is described.

Pre-Preparation: Cyclohexane was dried over activated alumina and stored under nitrogen. N-butyl lithium initiator was received at 15 weight percent in cyclohexane and was diluted with cyclohexane to 2 weight percent. Tetrahydrofuran was stored over activated alumina under nitrogen. Styrene and butadiene were purified over activated alumina. Epoxidized soybean oil was used. The polymerizations were performed in a 2-gallon stainless steel reactor, equipped with a jacket for temperature control, a double auger impeller, and baffles. A typical polymerization employed 2000 grams of monomers.

Polymerization process: The cyclohexane was initially charged to the reactor, followed by the tetrahydrofuran (0.10 per hundred monomer basis). The temperature was adjusted to about 60° C. and initiator was charged, followed by the first charge of styrene. After polymerization was completed, a sample of the first polymerization block was coagulated in nitrogen-sparged isopropanol, filtered, dried, and analyzed by Gel Permeation Chromatography. The polymerization was continued by sequential charges of monomers and/or initiators as desired. The coupling agent was charge and reacted at 100° C. for 15 minutes. The polymer was recovered by solvent evaporation and pelletized with a single screw extruder.

A total of seven SBC samples were prepared for testing. These SBC's are described in detail in Table 1 of the U.S. patent application to John D. Wilkey et al., assigned to Chevron Phillips Chemical Company, entitled Monovinylarene Conjugated Diene Copolymer Compositions For Acrylate Blends, filed on the same day as the present patent application. This application is referred to below as the “SBC Disclosure.”

### EXAMPLE 2

Example 2 relates to the blend of the invention. Pellets of the block copolymer of Example 1 containing 38 weight percent butadiene and 62 weight percent styrene were dry-blended by tumbling in a plastic bag with various amounts of a pelletized styrene methyl methacrylate (SMMA) product. This latter copolymer contains a bound styrene content of 70 weight percent, a methyl methacrylate content of 30 weight percent, a melt flow of about 2.2 g/10 minutes (ASTM D1238, Condition G), a specific gravity of 1.09, and a deflection temperature (annealed, ASTM D648) of 94° C., and is marketed by NOVA Chemicals Inc., Pittsburgh, Pa. under the trade name of NAS 30. The dry blending was done manually for about 30 seconds.

A prepared blend was molded in an Engel 1½ ounce molding machine at a barrel temperature of about 200° C., a mold temperature of 50° C., a screw speed of 120 rpm, and an injection pressure of about 0.7 Mpa. The total cycle time was about 45 seconds. The molded disk having an average thickness of 0.100 inches (2.54 mm) was tested in a Gardner IG-1120 heavy-duty impact tester according to ASTM D5420. The test was carried out with a 4-lb weight and a 40-inch guide-tube slot at room temperature. The impact energy was divided by the specimen thickness in millimeters to give an impact value in units of Kg/mm².

Table 1 shows a comparison of four examples of inventive blends to two commercial blends of SBC and SMMA (ZYLAR®220 and ZYLAR®530), available from NOVA Chemicals, Inc., Pittsburgh Pa. These two commercially available blends are identified as Comparative Example 1 (Comp. Ex. 1) and Comparative Example 2 (Comp. Ex. 2), respectively.

Inventive Blend Example 1 (Inv. Ex. 1) was prepared using the aforementioned techniques of Example 2, with an SBC prepared in accordance with Test 3 in Table 1 of the SBC Disclosure. The blend contained 36 weight percent SBC and 64 weight percent SMMA (NAS 30).

Inventive Blend Example 2 (Inv. Ex. 2) was prepared using the aforementioned techniques of Example 2, with an SBC prepared in accordance with Test 4 in Table 1 of the SBC Disclosure. The blend contained 35 weight percent SBC and 65 weight percent SMMA (NAS 30).

Inventive Blend Example 3 (Inv. Ex. 3) was prepared using the aforementioned techniques of Example 2, with an SBC prepared in accordance with Test 5 in Table 1 of the SBC Disclosure. The blend contained 35 weight percent SBC and 65 weight percent SMMA (NAS 30).

Inventive Blend Example 4 (Inv. Ex. 4) was prepared using the aforementioned techniques of Example 2, with an SBC prepared in accordance with Test 7 in Table 1 of the SBC Disclosure. The blend contained 36 weight percent SBC and 64 weight percent SMMA (NAS 30).

The blend of Comparative Example 1 comprised 50 percent by weight SBC comprised of 25 weight percent butadiene and 50 percent by weight SMMA (NAS 21 available from NOVA Chemicals, Inc.) The blend of Comparative Example 2 comprised 40 percent by weight SBC, and 60 weight percent of the SMMA (NAS 30). The exact weight percent of butadiene in the SBC of the blend of Comparative Example 2 is a trade secret but lies outside the range of that of the invention. The blends of Comparative Examples 1 and 2 were blended similar to that described in Example 2 for the blend of the invention.

TABLE 1

| | Sample | | | | | |
|---|---|---|---|---|---|---|
| | Comp. Ex. 1 | Comp. Ex. 2 | Inv. Ex. 1 | Inv. Ex. 2 | Inv. Ex. 3 | Inv. Ex. 4 |
| Peak Deformation (in) | .342 | .555 | .723 | 0.538 | 0.489 | 0.667 |
| Total Deformation (in) | .615 | .950 | 1.013 | 1.17 | 1.117 | 1.047 |
| Peak Energy (ft-lb) | 1.950 | 7.563 | 22.157 | 8.239 | 7.147 | 19.986 |
| Total Energy (ft-lb) | 3.280 | 12.732 | 30.411 | 13.601 | 13.196 | 31.641 |
| Peak Force (lbf) | 131.73 | 283.04 | 795.10 | 281.37 | 296.66 | 826.92 |
| Specimen (−) | 4 × 4 × .125 | 4 × 4 × .125 | 4 × 4 × .125 | 4 × 4 × .125 | 4 × 4 × .125 | 4 × 4 × .125 |
| Temperature (° C.) | 20 | 20 | 20 | 23 | 23 | 23 |
| Flexural Deflection (in) | 0.234 | 0.292 | 0.281 | 0.266 | 0.272 | 0.289 |
| Flexural Modulus (E+05 psi) | 3.485 | 3.061 | 2.947 | 3.113 | 2.983 | 2.607 |
| Flexural Stress (psi) | 10060 | 8063 | 8114 | 9019 | 8322 | 6873 |
| GARDNER Impact Resistance (in-lb.) | 5 | 15 | 9 | 54 | 42 | 158 |
| Haze (%) | 1.16 | 2.60 | 1.48 | 2.01 | 2.52 | 1.44 |
| IZOD Notched (ft lb/in) | 0.25 | 2.80 | 2.17 | 0.39 | 0.46 | 2.22 |
| Tensile @ Yield (psi) | 5514 | 4573 | 4861 | 5501 | 4966 | 4443 |
| % Elongation @ Yield (%) | 2.597 | 3.354 | 3.023 | 3.209 | 3.339 | 12.470 |
| Tensile @ Failure (psi) | 3567 | 3639 | 3671 | 3910 | 3916 | 3825 |
| % Elongation @ Break (%) | 36.610 | 65.810 | 58.990 | 33.57 | 39.66 | 65.990 |
| Tensile Modulus (E+05 psi) | 3.662 | 3.089 | 3.161 | 2.829 | 2.821 | 2.983 |

As can be seen in Table 1, the blend examples 1-4 of the invention show an increase in toughness over the blend of Comparative Examples 1 and 2, as indicated by the results for “Total Energy”, “Peak Energy”, “Peak Force”, “Gardner”, “IZOD” and “Elongation at Break”. Those of skill in the art will also recognize various advantageous balances of the parameters reported for the inventive blends over the comparative examples. The results also show better clarity than that of the blend of Comparative Example 2 as measured by “Haze”, and also as being observed to have a less “milky blue” appearance while maintaining comparable “Flexural Modulus”.

Table 2 shows the blends of the invention identified as Samples 1-7. This Table 2 shows the effect on the properties when the level of the styrene butadiene copolymer (SBC) or when the level of the styrene methyl methacrylate (SMMA) copolymer in the blends of the invention is varied. The weight percent of the SMMA is 75, 72.5, 70, 67.5, 65, 62.5, and 60, respectively, and the weight percent of the SBC is 25, 27,5, 30, 32.5, 35, 37.5, and 40, respectively. The SMMA is NAS 30. While the SBC from Inventive Example 1 in Table 1 was used to make this particular comparison, other SBC's can also be used as herein described.

TABLE 2

| | Sample | | | | | | |
|---|---|---|---|---|---|---|---|
| | 1 | 2 | 3 | 4 | 5 | 6 | 7 |
| SBC Loading (wt %) | 25 | 27.5 | 30 | 32.5 | 35 | 37.5 | 40 |
| Total Deformation (inch) | 0.548 | 0.966 | 1.027 | 1.132 | 1.044 | 0.916 | 0.948 |
| Peak Energy (ft-lb) | 5.076 | 7.017 | 7.406 | 8.765 | 15.039 | 23.282 | 23.879 |
| Total Energy (ft-lb) | 6.116 | 12.476 | 12.787 | 14.13 | 22.299 | 34.183 | 34.545 |
| Peak Force (lbf) | 267.45 | 321.54 | 318.77 | 322.56 | 509.91 | 797.52 | 783.32 |
| Flexural Deflection (inch) | 0.27 | 0.275 | 0.275 | 0.277 | 0.28 | 0.278 | 0.276 |
| Flexural Modulus (E+05 psi) | 3.727 | 3.444 | 3.391 | 3.205 | 3.086 | 2.936 | 2.777 |
| Flexural Strain (stress?) (psi) | 11960 | 10810 | 10270 | 9454 | 8945 | 8375 | 7638 |
| GARDNER Impact Resistance (in-lb) | 6 | 8 | 12 | 20 | 91 | 150 | 150 |
| Haze (%) | 1.8 | 1.77 | 1.71 | 1.74 | 1.77 | 1.82 | 1.79 |
| IZOD Notched (ft-lb/in) | 0.23 | 0.24 | 0.28 | 0.31 | 0.48 | 0.5 | 0.7 |
| IZOD Reversed Notched (ft lb/in) | 3.25 | 3.64 | 3.14 | 2.95 | 19.15 | 3.61 | 6.01 |
| IZOD Unnotched | 5.05 | 3.95 | 4.19 | 19.1 | 35 | 0 | 0 |
| Tensile @ Yield (psi) | 7281 | 6682 | 6179 | 5741 | 5305 | 4980 | 4587 |
| % Elongation @ Yield | 3.161 | 3.106 | 3.049 | 2.967 | 3.066 | 2.988 | 2.913 |
| Tensile @ Failure (psi) | 6907 | 4450 | 4264 | 3991 | 3879 | 3751 | 3553 |
| % Elongation @ Break | 4.873 | 23.13 | 26.59 | 31.13 | 37.92 | 43.91 | 49.01 |
| Tensile Modulus (E=05 psi) | 4.066 | 3.632 | 3.356 | 3.334 | 3.158 | 2.955 | 3.059 |

As can be seen in Table 2, the impact strength increases with increased SBC loading and the modulus decreases with increased SBC loading. The Haze ranges from 1.71 to 1.82.

While the present invention has been particularly set forth in terms of specific embodiments thereof, it will be understood in view of the instant disclosure that numerous variations upon the invention are now enabled yet reside within the scope of the invention. Accordingly, the invention is to be broadly construed and limited only by the scope and spirit of the claims now appended hereto.

What is claimed is:

1. A polymer blend composition comprising:
a monovinylarene conjugated diene block copolymer and at least 62.5 weight percent monovinylarene acrylate copolymer;
wherein said monovinylarene conjugated diene block copolymer comprises greater than 30 weight percent diene; and at least one tapered block; and
wherein said monovinylarene acrylate copolymer is a copolymer of at least 55.0 weight percent monovinylarene and not more than 45.0 weight percent acrylate.

2. The polymer blend composition of claim 1 wherein said monovinylarene conjugated diene block copolymer comprises from about 30 to about 40 weight percent diene.

3. The polymer blend composition of claim 2 wherein said monovinylarene conjugated diene block copolymer comprises at least 38 weight percent diene.

4. The polymer blend composition of claim 1 wherein said monovinylarene acrylate copolymer is a copolymer of about 70.0 weight percent monovinylarene and about 30.0 weight percent acrylate.

5. The composition of claim 1 wherein said monovinylarene acrylate copolymer is a styrene methyl methacrylate.

6. The polymer blend composition of claim 1 wherein said monovinylarene conjugated diene block copolymer is a styrene butadiene block copolymer.

7. The polymer blend composition of claim 1 wherein said composition has a haze of less than about 2.0% and has a visual appearance that is largely free of milky blue cast.

8. The polymer blend composition of claim 1 wherein said composition has a flexural modulus greater than 280000 pounds per square inch.

9. The polymer blend composition of claim 1 wherein said composition has Gardner impact strength greater than 5 ft-lbs/inch as measured according to ASTM D5420.

10. The polymer blend composition of claim 1 wherein said composition has a tensile elongation greater than about 20%.

11. A method for increasing the modulus and impact strength of a low haze polymer blend, comprising:
blending at least 62.5 weight percent of a monovinylarene acrylate copolymer with a monovinylarene conjugated diene block copolymer;
wherein said monovinylarene conjugated diene block copolymer is comprised of about 20 weight percent to about 70 weight percent diene; and
wherein said monovinylarene acrylate copolymer is comprised of at least 55.0 weight percent monovinylarene and no more than 45.0 weight percent acrylate.

12. The method of claim 11 wherein said blend composition has a haze of less than about 2.0%.

13. The method of claim 11 wherein said blend composition has a modulus greater than 280000 pounds per square inch.

14. The method of claim 11 wherein said blend composition has Gardner impact strength greater than 5 ft-lbs/inch as measured according to ASTM D5420.

15. A polymer blend composition comprising:
a monovinylarene conjugated diene block copolymer;
wherein said block copolymer has at least two modes;
wherein said block copolymer comprises at least one tapered block;
wherein the monovinylarene in the at least one tapered block comprises less than 25 weight percent of the block copolymer;
wherein said block copolymer comprises at least a first and a second charge of monovinylarene, wherein the first charge has a weight ratio to the second charge in the range of 1:2 to 2:1;
wherein said block copolymer comprises from about 30 to about 40 weight percent diene;
wherein a monoblock formed from a first charge of monovinylarene in the block copolymer preceding the tapered blocks has a molecular weight in the range of 25,000 to 65,000 grams per mole;
wherein said block copolymer has a blocking force less than 175 pounds,
wherein the composition comprises at least 62.5 weight percent monovinylarene acrylate copolymer;
wherein the composition has a haze of less than about 2.0%;
wherein the composition has a modulus greater than 280,000 pounds per square inch; and
wherein the composition has a Gardner impact strength greater than 5 ft-lbs/inch as measured according to ASTM D5420.

16. A polymer blend composition of claim 15 wherein said monovinylarene conjugated diene block copolymer comprises at least 38 weight percent diene.

17. A method for increasing the modulus and impact strength of a low haze polymer blend comprised of a monovinylarene conjugated diene block copolymer and a monovinylarene acrylate copolymer, comprising:
blending at least 62.5 wt % of the monovinylarene acrylate copolymer with the monovinylarene conjugated diene block copolymer;
wherein the block copolymer has at least two modes;
wherein the block copolymer comprises at least one tapered block;
wherein the monovinylarene in the at least one tapered block comprises less than 25 weight percent block copolymer;
wherein the block copolymer comprises at least a first and a second charge of monovinylarene, wherein the first charge has a weight ratio to the second charge in the range of 1:2 to 2:1;
wherein the block copolymer comprises from about 30 to about 40 weight percent diene; and
wherein a monoblock formed from a first charge of monovinylarene in the block copolymer preceding the tapered blocks has a molecular weight in the range of 25,000 to about 65,000 grams per mole; and
wherein said block copolymer has a blocking force of less than 175 pounds.

18. A method of claim 17 wherein said monovinylarene conjugated diene block copolymer comprises at least 38 weight percent diene.

19. The method of claim 17 wherein the blend has a haze of less than about 2.0%.

20. The method of claim 19 wherein the blend has a modulus greater than 280 kilopounds per square inch.

21. The method of claim 20 wherein the blend has Gardner impact strength greater than 5 ft-lbs/inch as measured according to ASTM D5420.

22. The polymer blend composition of claim 15 wherein said monovinylarene acrylate copolymer is styrene methyl methacrylate comprising at least 55 weight percent styrene and not more than 45 weight percent methyl methacrylate.

23. The method of claim 17 wherein said monovinylarene acrylate copolymer comprises styrene methyl methacrylate comprising which at least 55 weight percent styrene and not more than 45 weight percent methyl methacrylate.

24. An article made from the polymer blend composition of claim 1.

25. An article made from the polymer blend composition of claim 15.
